(19) United States
(12) Patent Application Publication
(10) Pub. No.: US 2010/0027833 A1
(43) Pub. Date: Feb. 4, 2010

(54) SPEAKER UNIT

(76) Inventor: Nobuaki Takahashi, Yamagata (JP)

Correspondence Address: YOUNG & THOMPSON, 209 Madison Street, Suite 500, Alexandria, VA, 22314, US

(21) Appl. No.: 12/514,879

(22) PCT Filed: Nov. 15, 2007
(86) PCT No.: PCT/JP2007/072197

§ 371 Date: Aug. 25, 2009

(30) Foreign Application Priority Data
Nov. 17, 2006 (JP) PCT/JP2006/322979

(51) Int. Cl. H04R 9/06

(52) U.S. Cl. 381/413; 381/412

(57) ABSTRACT

In the speaker device, a casing and a magnetic circuit are arranged to confront each other, and a vibration body is arranged between them. The outer circumferential part of the vibration body is supported by the casing. A supporting member passes through the inside of the vibrating body and extends from the casing to the magnetic circuit. Since the supporting member for supporting the magnetic circuit passes the inside of the vibration body, it is not necessary to provide a member such as a frame for supporting the magnetic circuit from outside of the vibration body. Therefore, there is no obstacle such as a frame in a propagating direction of the sound wave generated by the vibration body, and hence the non-directivity can be ensured.

### TECHNICAL FIELD

The present invention relates to a non-directional speaker device.

### BACKGROUND TECHNIQUE

The patent references 1 and 2 disclose, as a known speaker device, a speaker device having a conical diaphragm inclining from an inner circumference to an outer circumference and a voice coil bobbin extending from the inner circumference of the diaphragm to a magnetic circuit.

The above-mentioned speaker device has the following problems. First, it is necessary to form a frame surrounding the diaphragm, and hence the speaker device becomes large in size.

In addition, since a part of the frame is positioned in the propagating direction of the sound wave generated by the diaphragm, there is an adverse effect when the sound wave is propagated without directivity. Namely, the generated sound wave possesses the directivity. Also, since the sound wave propagates to a part of the frame and the sound wave is generated by the vibration of the frame itself, the acoustic characteristic is deteriorated.

Furthermore, since the voice coil bobbin formed in a manner extending from the inner circumference of the diaphragm to the magnetic circuit is long, the weight of the diaphragm itself becomes large, and the sensitivity is deteriorated.

Patent Reference 1: Japanese Patent Application Laid-open under No. H106-197398

Patent Reference 2: Japanese Patent Application Laid-open under No. 2006-101266

### DISCLOSURE OF INVENTION

### Problem Solved by the Invention

The above example is one of the problem that the present invention will solve. It is an object of the present invention to provide a small-size non-directional speaker device having a good acoustic characteristic.

### Means for Solving the Problem

According to the invention described in claim 1, the speaker device includes a vibrating body; a casing supporting an outer circumference of the vibrating body; a magnetic circuit arranged to confront the casing; and a support member passing through an inside of the vibrating body and extending from the casing to the magnetic circuit, wherein the vibrating body is positioned between the casing and the magnetic circuit, and wherein the supporting member supports the member constituting the magnetic circuit.

### BRIEF DESCRIPTION OF THE DRAWINGS

FIG. 1 is a sectional view of a speaker device according to a first embodiment of the present invention;

FIG. 2 is a sectional view of the speaker device according a modification of the first embodiment;

FIG. 3 is a sectional view of a speaker device according to a second embodiment of the present invention;

FIG. 4 is a sectional view of a speaker device according to a third embodiment of the present invention;

FIG. 5 is a sectional view of a speaker device according to a fourth embodiment of the present invention;

FIG. 6 is a sectional view of a speaker device according to a fifth embodiment of the present invention;

FIG. 7 is a sectional view of a speaker device according to a modification;

FIG. 8 is a sectional view of a speaker device according to another modification;

FIG. 9 is a sectional view of a speaker device according to still another modification;

FIG. 10 is a sectional view of a speaker device according to still another modification;

FIG. 11 shows graphs of acoustic characteristics of speaker device having a protection member and a speaker device having no protection member; and

FIG. 12 shows graphs of acoustic characteristics of speakers having equalizers of different shapes.

### BRIEF DESCRIPTION OF THE REFERENCE NUMBER

1, 1a, 1b, 1c, 1d, 1e, 1f, 1g, 1h Speaker Device
10, 10b, 10c, 10d, 10e Magnetic Circuit
20 Vibration Body
21 Voice Coil Bobbin
22 Voice Coil
23 Diaphragm
24 Edge
25 Damper
31 Casing
40, 40x, 40y, 40z Equalizer

### BEST MODE TO EXERCISE THE INVENTION

According to a preferred embodying form of the present invention, a speaker device includes a vibrating body; a casing supporting an outer circumference of the vibrating body; a magnetic circuit arranged to confront the casing; and a support member passing through an inside of the vibrating body and extending from the casing to the magnetic circuit, wherein the vibrating body is positioned between the casing and the magnetic circuit, and wherein the supporting member supports the member constituting the magnetic circuit.

In the above speaker device, the casing and the magnetic circuit are arranged to confront each other, and the vibrating body is arranged between them. The outer circumference of the vibrating body is supported by the casing. The supporting member passes through the inside of the vibrating body, and extends from the casing to the magnetic circuit.

With this configuration, since the supporting member supporting the magnetic circuit passes the inside of the vibration body, it is not necessary to provide a member such as a frame which supports the magnetic circuit from outside of the vibrating body. Therefore, there is no obstacle in a propagating direction of the sound wave generated by the vibrating body, non-directivity can be ensured.

In one form of the above speaker device, the magnetic circuit is an external-magnet type magnetic circuit having a magnet and a yoke, and the member supported by the supporting member is the yoke. In this form, the magnetic circuit is constituted as the external-magnet type magnetic circuit having the magnet and the yoke, and the supporting member is constituted to support the yoke, out of the constitutional elements of the magnetic circuit.

In another form of the above speaker device, the magnetic circuit is an internal-magnet type magnetic circuit having a yoke, a magnet and a plate positioned on a lower surface side of the magnet, and the member supported by the supporting member is the plate. In this form, the magnetic circuit is constituted as the internal-magnet type magnetic circuit having a yoke, a magnet and a plate positioned on a lower surface side of the magnet, and the supporting member is constituted to support the plate, out of the constitutional elements of the magnetic circuit.

In still another form of the above speaker device, the magnetic circuit is an external-magnet type magnetic circuit having a yoke, a magnet and a plate positioned on a lower surface side of the magnet, and the member supported by the supporting member is the yoke. In this form, the magnetic circuit is constituted as an external-magnet type magnetic circuit having a yoke, a magnet and a plate extending from the yoke to the casing. The supporting member is constituted to support the plate (extending from the yoke to the casing), out of the constitutional elements of the magnetic circuit.

In still another form of the above speaker device, the casing is provided with a hole communicating with an outside. The hole has a role of a ventilation hole which exchanges the air inside the speaker with the air outside the speaker device. Thereby, the temperature increase in the vibration body and the magnetic circuit can be suppressed. Also, the hole has a role of adjusting the air pressure inside the vibration body. In addition, in a case of a bass-reflex type speaker device in which the casing functions as a cabinet, the low frequency range can be widened (the lower limit frequency can be small) when the casing has the hole.

In a preferred embodiment of the above speaker device, there may be provided an equalizer which is formed to surround the magnetic circuit.

In another preferred embodiment of the above speaker device, the vibrating body includes a diaphragm, a voice coil bobbin and a damper, and an outer circumferential part of the diaphragm is supported by the casing. An inner circumferential part of the diaphragm is connected to an outer circumference of the voice coil bobbin, and an inner circumference of the damper is connected to the outer circumference of the voice coil bobbin. An outer circumference of the damper is connected to the member constituting the magnetic circuit.

In another preferred example of the above speaker device, the magnetic circuit is an external-magnet type magnetic circuit having a yoke, a magnet, a plate and a damper supporting member arranged on a lower surface of the plate, and the member to which the outer circumference of the damper is connected is the damper supporting member.

In another preferred embodiment of the above speaker device, the diaphragm and the edge are integrally formed.

In another formed of the above speaker device, a plurality of the supporting members may be arranged. For example, there may be provided a first supporting member such as a bolt, and a second supporting member of cylindrical shape to which the first supporting member is inserted.

In another form of the above speaker device, a protection net may be arranged to surround the diaphragm of the vibration body, thereby to protect the diaphragm. Also, the magnet may be formed by rare earth magnetic material or ferrite (ceramics containing iron oxide as a main component).

In another form of the above speaker device, a metal material may be arranged on a side face of the magnet confronting a side face of the yoke, or a side face of the yoke confronting a side face of the plate. Thereby, it can be prevented that the inductance increases, and the sensitivity of the speaker device can be improved.

In another preferred example of the speaker device, the equalizer has a bottom part and a rise-up part. The outside diameter of the rise-up part is substantially equal to the outside diameter of the casing or is smaller than the outside diameter of the casing, and the outer circumferential side face of the rise-up part is formed in a flat plate shape or a curved shape.

In another preferred example of the above speaker device, the equalizer has a bottom part and a rise-up part. The outside diameter of the rise-up part is smaller than the outside diameter of the casing, and is substantially equal to or smaller than the inside diameter of the casing. The outer circumferential side face of the rise-up part is formed in a curved shape.

In another preferred example of the above speaker device, the voice coil bobbin extends from the inner circumference of the diaphragm to the magnetic circuit.

By directing the voice coil bobbin from the inner circumference of the diaphragm to the magnetic circuit, the length of the voice coil bobbin can be relatively small. Namely, the voice coil bobbin can be lightened, and the entire weight of the vibrating body can be reduced.

In addition, by making the length of the voice coil bobbin relatively small, the vibration of the voice coil can be easily propagated to the diaphragm, and the reproduction frequency range particularly in high frequency range can be widened.

In another preferred example of the speaker device, the magnetic circuit includes a plate, a magnet and a yoke. The voice coil bobbin extends from an inner circumferential part of the diaphragm to the magnetic circuit, and magnetic fluid is inserted between the plate or the yoke of the magnetic circuit and the voice coil. By using magnetic fluid, it can be prevented that the vibration body contacts, during its vibration, the magnet and the plate or the yoke constituting the magnetic circuit and abnormal sound is generated.

In another preferred example, the above speaker device further includes a terminal supported by the supporting member, and the terminal is provided between the vibrating body and the casing.

In another preferred example, the above speaker device further includes a terminal supported by the supporting member. The terminal is provided between the vibrating body and the casing, and the voice coil bobbin is provided between the terminal and the magnetic circuit. When the voice coil bobbin is arranged between the terminal and the magnetic circuit, it can be prevented that the voice coil bobbin, vibrating due to the vibration of the voice coil, contacts the terminal and generates abnormal sound. Further, by making the length of the voice coil bobbin relatively small, i.e., by lightening the voice coil bobbin, the entire weight of the vibration body can be reduced. Also, by making the length of the voice coil bobbin relatively small, the vibration of the voice coil can be easily propagated to the diaphragm, and the reproduction frequency range particularly in high frequency range can be widened.

### EMBODIMENTS

The preferred embodiments of the present invention will now be described below with reference to the attached drawings.

### 1st Embodiment

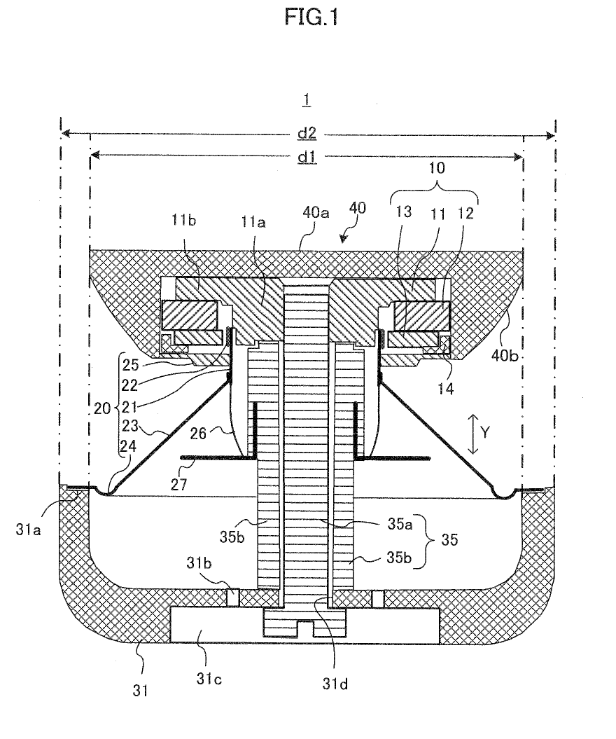

FIG. 1 is a sectional view of a speaker device according to a first embodiment of the present invention. In FIG. 1, the speaker device 1 roughly includes a magnetic circuit 10, a vibration body 20, a casing 31 and an equalizer 40.

The casing 31 has a substantially pot shape, and functions as a base of the speaker device 1. A recess part 31c is formed at the outside face of the bottom of the casing 31, and a hole 31d is formed substantially at the center of the recess part 31c. Into the hole 31d, a first supporting member 35a constituting the supporting member 35 is inserted. The first supporting member may be a bolt, for example, and the head of the bolt is received in the recess part 31c.

The first supporting member 35a is inserted into the inside of a second supporting member 35b having a substantially cylindrical shape and constituting the supporting member 35. The supporting member 35 has a role of supporting the magnetic circuit 10. Specifically, the supporting member 35 is positioned between the casing 31 and the magnetic circuit 10, and supports the casing 31 and the magnetic circuit 10 such that they confront with each other.

The casing 31 is provided with a plurality of holes 31b in its circumferential direction within the range of the recess part 31c. The hole 31b functions as a ventilation hole which exchanges the air in the speaker device, i.e., between an internal space of the speaker formed by the vibration body 20 and the casing 31 and the outside of the casing 31, thereby suppressing the temperature increase inside of the vibration body and the magnetic circuit. In addition, the hole 31b has an air pressure adjusting function which prevents that the air pressure in the vibration body so increases that the vibration body 20 cannot be appropriately controlled. Also, in a case of a bass-reflex type speaker device in which the casing functions as a cabinet, if the hole is formed on the casing, the low frequency sound range can be enlarged (i.e., the lower limit frequency can be small).

The vibration body 20 includes a voice coil bobbin 21, a voice coil 22, a diaphragm 23, an edge 24 and a damper 25. The diaphragm 23 of conical shape is positioned to cover the casing 31. The edge 24 is formed at the outer circumference (outer circumferential part) of the diaphragm 23, and the outer circumferential end of the edge 24 is supported by the casing 31 at the position of the edge supporting part 31a formed at the annular upper surface of the casing 31. The inner circumference (circumferential part) of the diaphragm 23 is attached to the outer circumferential wall of the voice coil bobbin 21 having a cylindrical shape. The voice coil 22 is provided on the outer circumferential wall of the upper end part (i.e., at the end of the magnetic circuit side) of the voice coil bobbin 21.

The magnetic circuit 10 is provided on the upper part, i.e., on the end opposite to the casing 31, of the supporting member 35. Specifically, the magnetic circuit 10 is received in the recess part of the equalizer 40. In other words, the magnetic circuit 10 is surrounded by the equalizer 40. The magnetic circuit 10 is an external-magnet type magnetic circuit including a yoke 11, an annular magnet 12 and an annular plate 13. The yoke 11 has a body part 11a of substantially cylindrical shape and a flange part 11b which extends from the upper end of the body part 11a to the outer circumference direction. The yoke 11 is supported by the supporting member 35. Specifically, the first supporting member 35a is inserted into the central hole of the yoke 11, in such a state that the yoke 11 is positioned on the second supporting member 35b.

A damper supporting member 14 of substantially annular shape is provided on the lower face of the plate 13, and the damper 25 of annular shape is provided on the lower face of the damper supporting member 14. Since the damper supporting member 14 is attached to the inner wall of the recess part of the equalizer 40, the damper 25 movably supports, in a state being fixed to the equalizer 40, the voice coil bobbin 21. The damper 25 is attached to the voice coil bobbin 21 such that the voice coil 22 is positioned within a magnetic gap formed between the yoke 11 and the plate 13.

The annular magnet 12 is attached to the lower face of the flange part 11b of the yoke 11, and may be a rare earths magnet. The plate 13 is attached to the lower face of the magnet 12. Thereby, the magnetic gap is formed between the yoke 11, i.e., the outer circumferential wall of the substantially cylindrical body part 11a, and the inner circumferential wall of the plate 13.

The second supporting member 35b is provided with terminals 27 at two positions along its circumferential direction, and the end of the voice coil 22 wound around the voice coil bobbin 21 is connected to the terminal 27 via the lead wire 26.

In this manner, the vibration body 20 is fixed to the voice coil bobbin 21 at its inner circumferential end and is fixed to the edge supporting member 31a of the upper end surface of the casing 31 at its outer circumferential end, so as to be movable in an up-down direction in the figure (the arrow Y direction) by the damper 25. When an input signal is supplied, via the terminal 27 and the lead wire 26, to the voice coil 22 which is arranged within the magnetic gap formed between the yoke 11 and the plate 13, the vibration of the vibration body 20 is generated in the arrow Y direction, and the sound wave corresponding to the input signal is outputted.

In the speaker device 1 configured in the above manner, the vibration body 20 is positioned between the casing 31 and the magnetic circuit 10, and the supporting member 35 passing through the inside of the vibration body 20 supports the casing 31 and the magnetic circuit 10 at the confronting positions. Therefore, in comparison with a speaker device in which the magnetic circuit positioned above the diaphragm is supported by the frame arranged to surround the diaphragm, there is no obstacle such as the frame in the propagating direction of the sound wave generated by the vibration body 20. Therefore, it can be prevented that unnecessary sound generated by the vibration of the frame itself due to the sound wave deteriorates the acoustic characteristic, and that the frame serves as an obstacle against the propagating sound wave to cause the directivity of the sound wave. Thus, it becomes possible to radiate the sound wave in an omni-direction. In addition, since it is not necessary to arrange the frame to surround the outer circumference of the diaphragm 23, the entire size of the speaker device can be small.

Further, since the magnetic circuit 10 is close to the inner circumferential end of the diaphragm 23, the length of the voice coil bobbin 21 in the vibration direction (the arrow Y direction) can be short. Thereby, the weight of the vibration body 20 can be reduced, and the sensitivity can be improved.

Further, since the semi-apex angle of the diaphragm 23 can be small, the high frequency band resonant frequency can be large and the acoustic characteristic in the high frequency range can be improved. It is noted that “the semi-apex angle of the diaphragm” indicates the angle created by the axis direction of the diaphragm and the inclined plane of the diaphragm.

### Modification of 1st Embodiment

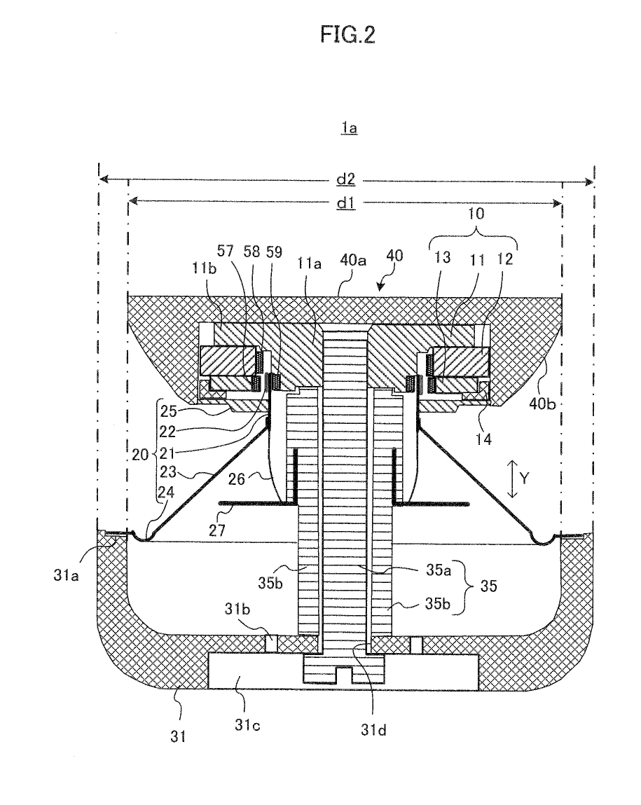

FIG. 2 shows a sectional view of the speaker device according to a modification of the first embodiment. In this speaker device 1a, a metal member 58 is provided on the inner circumferential wall of the magnet 12 which confronts the outer circumferential wall of the yoke 11. Alternatively or additionally, a metal member 59 is provided on the outer circumferential wall of the yoke 11 which confronts the inner circumferential wall of the plate 13. Further, alternatively or additionally, a metal member 57 is provided on the inner circumferential wall of the plate 13. The metal members 57, 58 and 59 may be a ring-shape member made of copper, for example. By providing the metal members 57, 58 and 59, the acoustic characteristic in the high frequency range can be improved.

### 2nd Embodiment

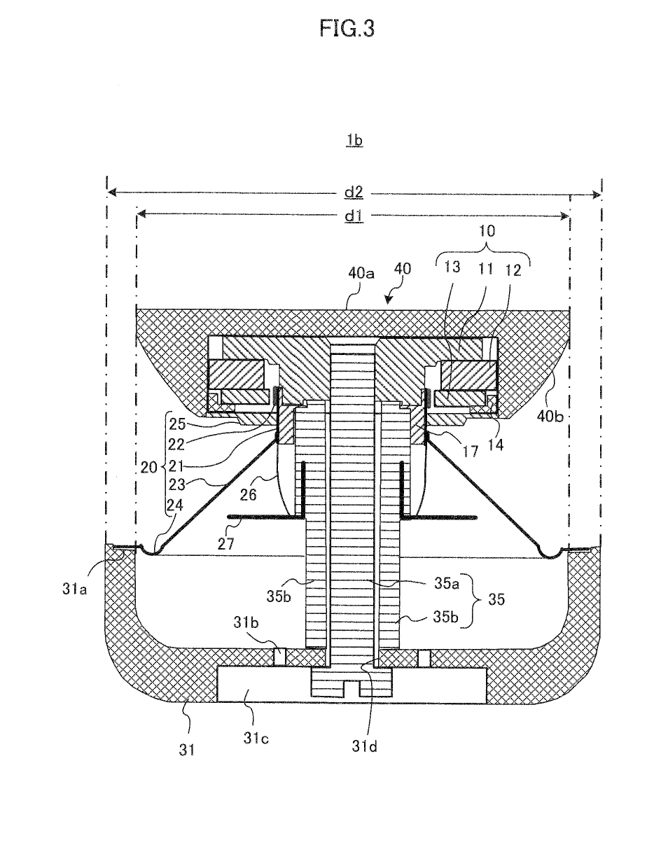

FIG. 3 shows a configuration of the speaker device according to the second embodiment of the invention. The speaker device 1b shown in FIG. 3 is different from the speaker devices 1a and 1b according to the first embodiment in that the speaker device 1b has an annular plate 17 extending into the inside of the diaphragm 23 from the yoke 11. Namely, the speaker device 1b according to the second embodiment has the annular plate 17 surrounding the second supporting member 35b under the yoke 11, in addition to the plate 13 attached to the lower face of the magnet 12. Thereby, the magnetic flux within the magnetic gap can be uniformly distributed, and it is possible to reduce the distortion caused by the ununiformity of the magnetic flux distribution.

### 3rd Embodiment

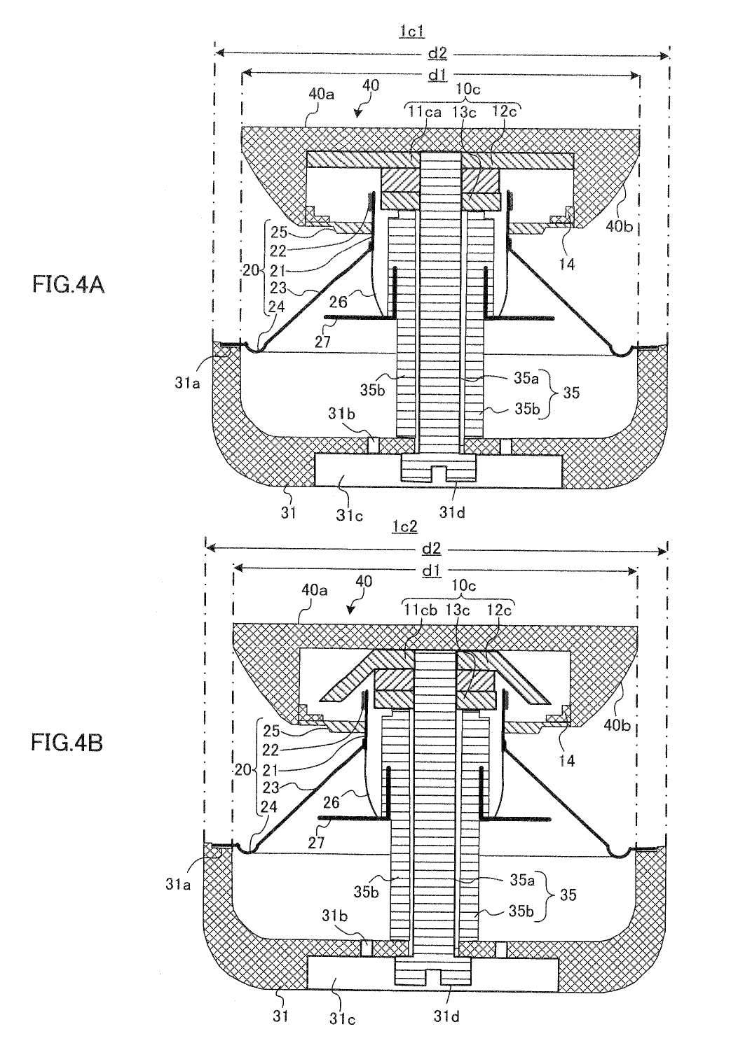

FIGS. 4A and 4B show configurations of the speaker device according to the third embodiment of the invention. In the speaker devices 1, 1a and 1b according to the first and the second embodiments, the magnetic circuit 10 is formed as an external-magnet type magnetic circuit. In contrast, in the speaker devices 1c1 and 1c2 according to the third embodiment, the magnetic circuit 10c is formed as an internal-magnet type magnetic circuit. Specifically, as shown in FIGS. 4A and 4B, the magnetic circuit 10c includes a disc-shaped yoke 11c, an annular magnet 12c provided on the lower face of the yoke 11c, and an annular plate 13c provided on the lower face of the magnet 12c. The components other than the above are identical to those of the first and the second embodiments.

### 4th Embodiment

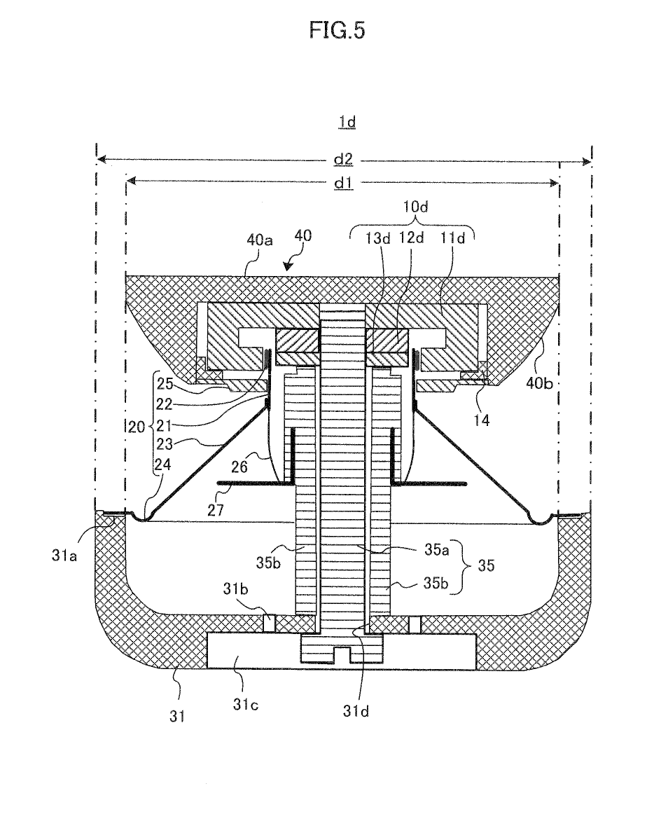

FIG. 5 shows a configuration of the speaker device according to the fourth embodiment of the invention. In the speaker devices 1, 1a and 1b of the first and the second embodiments, the magnetic circuit 10 is formed as an external-magnet type magnetic circuit. In contrast, in the speaker device 1d according to the fourth embodiment, the magnetic circuit 10d is formed as an internal-magnet type magnetic circuit. Specifically, as shown in FIG. 5, the magnetic circuit 10d includes a yoke 11d, an annular magnet 12d, and an annular plate 13d provided on the lower face of the magnet 12d. The components other than the above are identical to those of the first and the second embodiments.

### 5th Embodiment

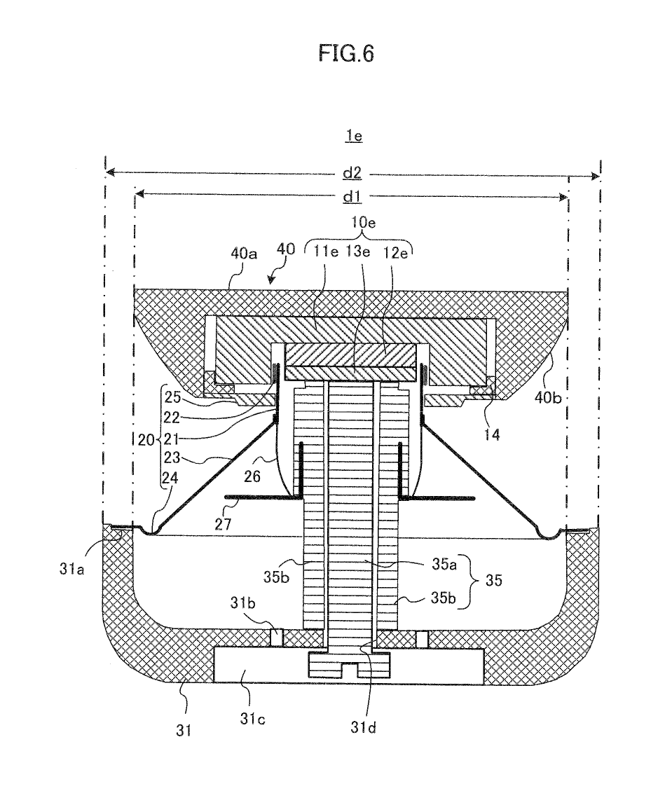

FIG. 6 shows a configuration of the speaker device according to the fifth embodiment of the invention. In the speaker devices 1, 1a and 1b of the first and the second embodiments, the magnetic circuit 10 is formed as an external-magnet type magnetic circuit. In contrast, in the speaker device 1e according to the fifth embodiment, the magnetic circuit 10e is formed as an internal-magnet type magnetic circuit. Specifically, as shown in FIG. 6, the magnetic circuit 10e includes a yoke 11e, an annular magnet 12e, and an annular plate 13e provided on the lower face of the magnet 12e. The components other than the above are identical to those of the first and the second embodiments.

[Modifications]

In the speaker devices according to the above-described embodiments, a protection net, a cylindrical protection guard or a protection member may be provided to surround the diaphragm 23, thereby to protect the diaphragm.

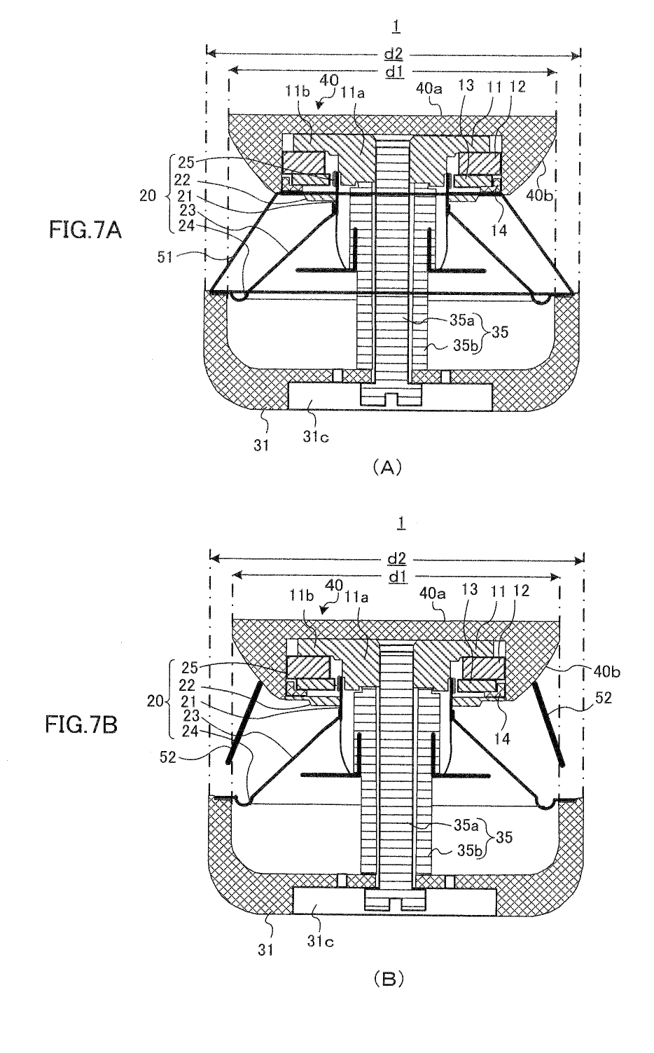

FIG. 7A is a sectional view of showing the state in which the protection net 51 is provided. The protection net 51 is attached to the speaker device 1 so as to cover the space between the equalizer 40 and the casing 31. Since the protection net and the cylindrical protection guard is formed uniformly in its circumferential direction, the sound wave can be propagated without directivity if the protection net or the cylindrical protection guard is arranged around the diaphragm.

FIG. 7B is a sectional view showing the state in which the protection members 52 are attached. Each of the protection members 52 is a stick-shaped member, and a plurality of protection members 52 are attached in the circumferential direction with an equal interval. By providing the protection members 52 in the circumferential direction with an equal interval, the sound wave can be propagated without directivity.

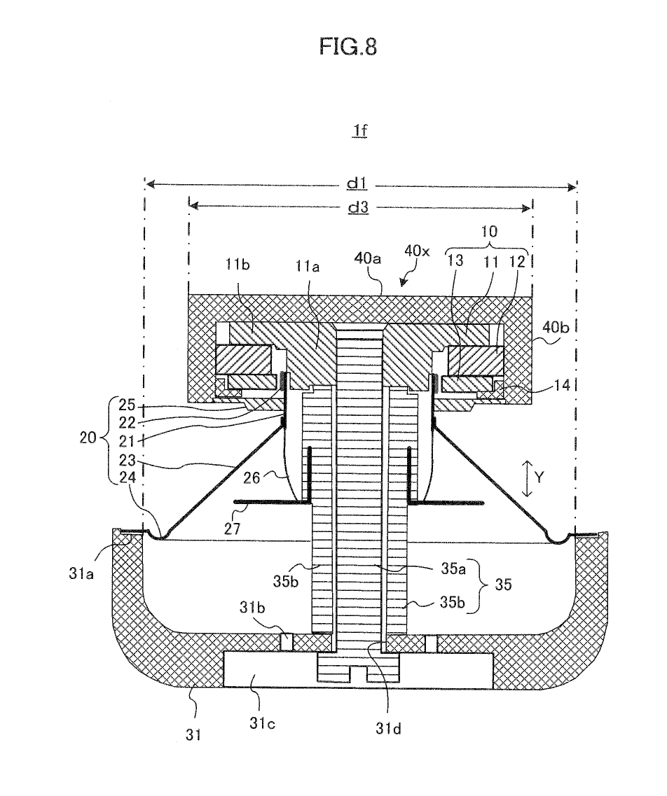

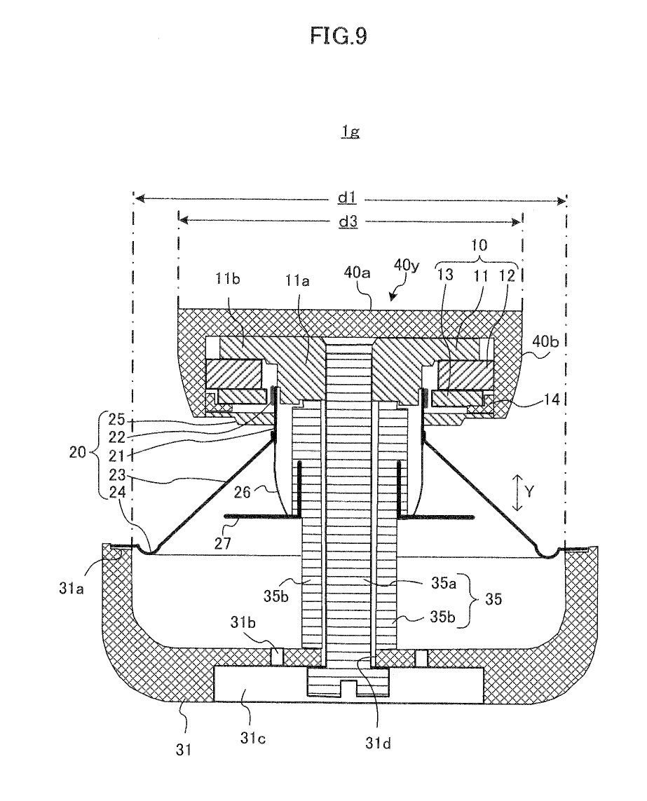

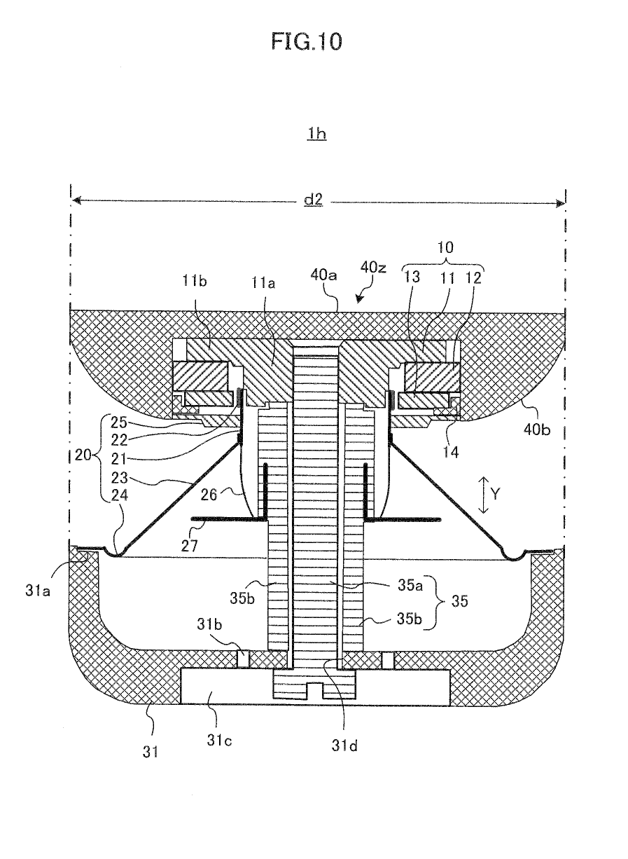

In the speaker devices 1, 1a, 1b, 1c1, 1c2, 1d and 1e (hereinafter referred to as “1v”), the equalizer 40 has the disc-shaped bottom part 40a and the rise-up part 40b rising up from the outer circumference of the bottom part 40a. In the embodiments, the shape of the outer circumferential side face of the rise-up part 40b may be changed. The equalizer shapes shown in FIGS. 8 to 10 are the examples. In the equalizer 40 provided in the speaker device 1v according to each of the above-described embodiments, the outside diameter d1 is smaller than the outside diameter d2 of the casing 31, and is substantially equal to the inside diameter of the casing 31. Further, the outer circumferential side face of the rise-up part 40b of the equalizer 40 is a curved surface. In contrast, the equalizer 40x provided in the speaker device 1f shown in FIG. 8 has such a shape that the outside diameter d3 is smaller than the inside diameter d1 of the casing 31. Also, the outer circumferential side face of the rise-up part 40b of the equalizer 40x has a flat plate shape. The equalizer 40y provided in the speaker device 1g shown in FIG. 9 has such a shape that the outside diameter d3 is smaller than the inside diameter d1 of the casing 31. Also, the outer circumferential side face of the rise-up part 40b of the equalizer 40y is a curved surface. The equalizer 40z provided in the speaker device 1h shown in FIG. 10 has such a shape that the outside diameter d2 is substantially equal to the outside diameter of the casing 31. Further, the outer circumferential side face of the rise-up part 40b of the equalizer 40z is a curved surface.

[Experimental Result]

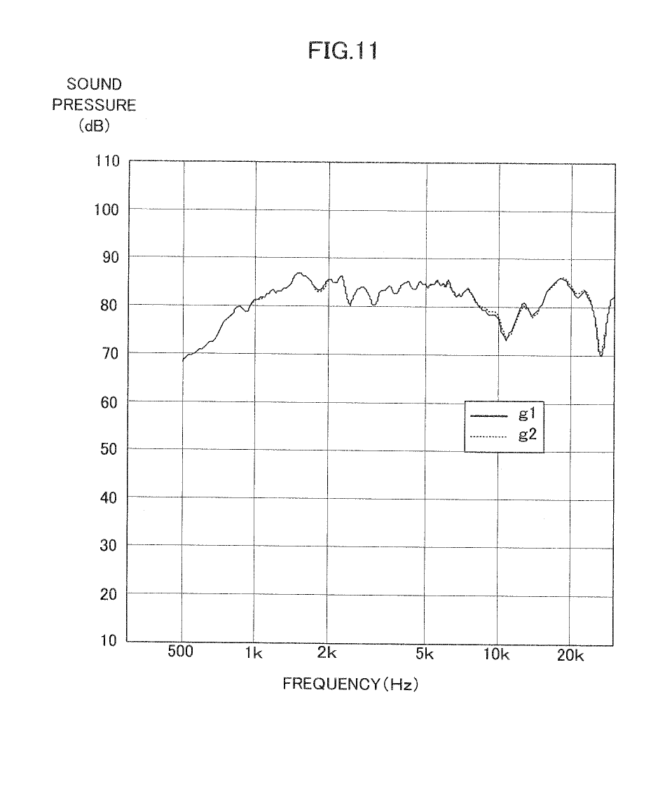

FIG. 11 shows an experimental result in which the speaker device 1v, shown in FIGS. 1 to 7, to which the protection member 52 is not attached is compared with the speaker device 1v to which the protection member 52 is attached, in view of the acoustic characteristics. In FIG. 11, the vertical axis represents sound pressure (dB) and the horizontal axis represents frequency (Hz). Also in FIG. 11 the graph g1 of solid line shows the acoustic characteristic of the speaker device 1v to which the protection member 52 is attached, and the graph g2 of the broken line shows the acoustic characteristic of the speaker device 1v to which the protection member 52 is not attached. As shown in FIG. 11, the acoustic characteristic of the speaker device 1v to which the protection member 52 is attached is substantially similar as the acoustic characteristic of the speaker device 1v to which the protection member 52 is not attached. It is confirmed that if the protection member 52 is attached, an adverse effect such that the protection member 52 resonate to generate sound wave, for example, can be prevented.

In addition, in a case that the protection member 52 provided on the casing 31 is supported in a manner extending towards the magnetic circuit 10 or the equalizer 40, there is a following problem, for example. When the voice coil 22 vibrates, e.g., the voice coil 22 vibrates to the sound radiation direction, the magnetic circuit 10 receives magnetic repulsive force to vibrate to the side opposite to the sound radiation direction. This vibration is propagated to the protection member 52 to generate resonance, and the protection member 52 generates sound wave. Also, when the voice coil 22 vibrates, the damper 25 vibrates to follow the vibration of the diaphragm 23. Therefore, the vibration of the damper 25 is propagated to the protection member 52 to generate the resonance, and the protection member 52 generates the sound wave. Also, when the voice coil 22 vibrates, the air pressure acts on the casing 31 from the backface (the face opposite to the sound radiation direction) of the diaphragm 23 to the casing 31 by the vibration of the diaphragm 23, the casing 31 vibrates. Therefore, the vibration of the casing 31 is propagated to the protection member 52 to generate resonance, and the protection member 52 generates the sound wave. By the way, the protection member 52 provided on the casing 31 is formed as the shape shown in FIG. 7B. FIG. 11 illustrates that, with this shape, it is possible to suppress the generation of such as resonance due to the vibration of the magnetic circuit 10, the damper 25 and the casing 31, and it is possible to prevent that the protection member 52 generates the sound wave. Also, by making the width of the protection member 52 smaller than the wavelength of corresponding to a predetermined frequency, it is suppressed that the protection member 52 resonates by the sound wave generated by the diaphragm 23 and generates the sound wave. For example, when the predetermined frequency is set to approximately 40 Hz, the wavelength is approximately 3.5 mm, and the width of the protection member 52 is set to be smaller than this wavelength value.

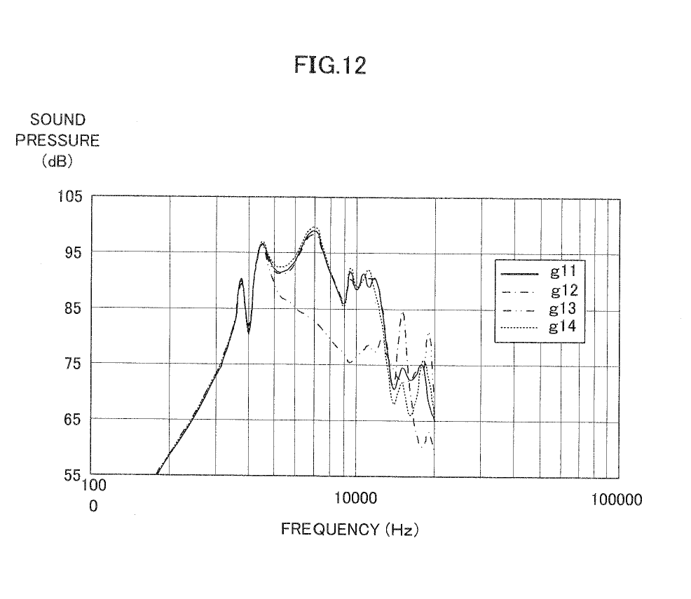

Next, FIG. 12 shows the acoustic characteristics of the speaker devices having the equalizer 40 or 40x to 40z shown in FIGS. 1 and 8 to 10. In FIG. 12, the vertical axis represents sound pressure (dB), and the horizontal axis represents frequency (Hz). Also, in FIG. 12, the graph g11 of solid line shows the acoustic characteristic of the speaker 1 having the equalizer 10 shown in FIG. 1, the graph g12 of dashed line shows the acoustic characteristic of the speaker 1f having the equalizer 40x shown in FIG. 8, the graph g13 of chain double-dashed line shows the acoustic characteristic of the speaker 1g having the equalizer 40y shown in FIG. 9, and the graph g14 of broken line shows the acoustic characteristic of the speaker 1h having the equalizer 40z shown in FIG. 10, respectively. Out of the equalizers 40 and 40x to 40z, the shape of the equalizer 40 shown in FIG. 1 is particularly preferable compared with the shapes of the equalizers 40x to 40z shown in FIGS. 8 to 10 because the peak and dip are relatively small from the low frequency range to the high frequency range.

Further, in each of the speaker devices described above, magnetic fluid may be put within the magnetic gap. When the vibration body 20 is lightened, by using the magnetic fluid, it can be prevented that the vibration body 20 contacts, during its vibration, the magnet, the plate or the yoke forming the magnetic circuit to generate abnormal sound.

Further, in each of the speaker devices described above, the voice coil bobbin 21 may be directed from the inner circumference of the diaphragm 23 to the magnetic circuit 10, thereby to reduce the length of the voice coil bobbin 21 to be relatively small. By using such a voice coil bobbin 21, the voice coil bobbin 21 can be lightened, and the entire weight of the vibration body 20 can be reduced. Also, by reducing the length of the voice coil bobbin 21 to be relatively small, the vibration of the voice coil 22 can be easily propagated to the diaphragm 23, and the reproduction frequency range particularly in the high frequency range can be widened.

Further, in each of the speaker devices described above, the terminal 27 supported by the supporting member 35 may be provided between the vibration body 20 and the casing 31, and the voice coil bobbin 21 may be provided between the terminal 27 and the magnetic circuit 10. By arranging the voice coil bobbin 21 between the terminal 27 and the magnetic circuit 10, it becomes possible to prevent the voice coil bobbin 21 from contacting the terminal 27 and generating abnormal sound by contacting the terminal 27, if the voice coil bobbin 21 vibrates due to the vibration of the voice coil 22. Further, by making the length of the voice coil bobbin 21 relatively small, i.e., by lightening the voice coil bobbin 21, the entire weight of the vibration body 20 can be reduced. Further, by making the length of the voice coil bobbin 21 relatively small, the vibration of the voice coil 22 can be easily propagated to the diaphragm 23, and the reproduction range particularly in the high frequency range can be widened.

### INDUSTRIAL APPLICABILITY

The present invention can be applied to a small-size speaker device used in an electronic equipment.

1-19. (canceled)

20. A speaker device comprising a vibrating body; a casing supporting an outer circumference of the vibrating body; a magnetic circuit arranged to confront the casing; and a support member passing through an inside of the vibrating body and extending from the casing to the magnetic circuit, wherein the vibrating body is positioned between the casing and the magnetic circuit, and wherein the supporting member supports a member constituting the magnetic circuit.

21. The speaker device according to claim 20, wherein the casing is provided with a hole communicating with an outside.

22. The speaker device according to claim 20, further comprising an equalizer which is formed to surround the magnetic circuit.

23. The speaker device according to claim 20, wherein the vibrating body includes a diaphragm, an edge, a voice coil bobbin and a damper, wherein an outer circumferential part of the diaphragm is supported by the casing through the edge, wherein an inner circumferential part of the diaphragm is connected to an outer circumference of the voice coil bobbin, wherein an inner circumferential part of the damper is connected to the outer circumference of the voice coil bobbin, and wherein an outer circumferential part of the damper is connected to the member constituting the magnetic circuit.

24. The speaker device according to claim 23, wherein the diaphragm and the edge are integrally formed.

25. The speaker device according to claim 20, wherein the magnetic circuit is an external-magnet type magnetic circuit having a yoke, a magnet, a plate and a damper supporting member arranged on a lower face of the plate, and wherein the member to which the outer circumference of the damper is connected is the damper supporting member.

26. The speaker device according to claim 20, wherein a protection net or a protection member is arranged to surround a diaphragm which the vibration body includes.

27. The speaker device according to claim 25, a metal material is arranged on a side face of the magnet confronting a side face of the yoke, or a side face of the yoke confronting a side face of the plate, or a side face of the plate confronting a side face of the yoke.

28. The speaker device according to claim 22, wherein the equalizer has a bottom part and a rise-up part, wherein an outside diameter of the rise-up part is substantially equal to or smaller than an outside diameter of the casing, and wherein an outer circumferential side face of the rise-up part is formed in a shape of a flat plate or a curved surface.

29. The speaker device according to claim 22, wherein the equalizer has a bottom part and a rise-up part, wherein an outside diameter of the rise-up part is smaller than an outside diameter of the casing, and is substantially equal to or smaller than an inside diameter of the casing, and wherein an outer circumferential side face of the rise-up part is formed in a shape of a curved surface.

30. The speaker device according to claim 23, wherein the voice coil bobbin extends from the inner circumferential part of the diaphragm to the magnetic circuit.

31. The speaker device according to claim 20, further comprising a terminal supported by the supporting member, wherein the terminal is provided between the vibrating body and the casing.

32. The speaker device according to claim 23, further comprising a terminal supported by the supporting member, wherein the terminal is provided between the vibrating body and the casing, and wherein the voice coil bobbin is provided between the terminal and the magnetic circuit.

33. The speaker device according to claim 20, wherein the casing includes a bottom part which supports one end of the supporting member and an outer circumferential side part surrounding the bottom part, and wherein the outer circumferential side part of the casing supports the outer circumferential part of the diaphragm of the vibration body.

34. The speaker device according to claim 20, wherein the casing includes a bottom part which supports one end of the supporting member and an outer circumferential side part surrounding the bottom part, and wherein the outer circumferential side part of the casing extends to a position near the outer circumferential part of the diaphragm of the vibration body.

35. The speaker device according to claim 33, wherein the vibration body includes at least a diaphragm and a voice coil bobbin supporting the voice coil, and wherein the voice coil bobbin includes one end part which supports the voice coil, and the other end part positioned near an inner circumferential part of the diaphragm.

36. The speaker device according to claim 35, wherein the magnetic circuit includes a plate, a magnet and a yoke, wherein the one end part of the voice coil bobbin is positioned in a magnetic gap formed between the plate and the yoke, and wherein magnetic fluid is inserted between the plate or yoke of the magnetic circuit, and the voice coil.

37. The speaker device according to claim 35, wherein a part of the supporting member is inserted to the member constituting the magnetic circuit.

38. The speaker device according to claim 22, wherein the magnetic circuit includes at least a yoke, wherein a part of one of the plurality of supporting members is inserted to the yoke, and wherein another supporting member supports a side face of the yoke on the side of the casing.

39. The speaker device according to claim 22, wherein the magnetic circuit includes a yoke, a magnet and a plate, wherein a part of one of the plurality of supporting members is inserted to the yoke, and wherein another supporting member supports the side face of the magnet or the plate on the side of the casing.

40. The speaker device according to claim 20, comprising a plurality of the supporting members, wherein one of the plurality of supporting members has a cylindrical shape surrounding another one of the plurality of supporting members.

41. An electronic equipment comprising the speaker device according to claim 20.
